(19) United States
(12) Patent Application Publication
(10) Pub. No.: US 2014/0050596 A1
(43) Pub. Date: Feb. 20, 2014

(54) Speed Regulator

(71) Applicant: Kalle TANSKANEN, Joensuu (FI)

(72) Inventor: Kalle TANSKANEN, Joensuu (FI)

(21) Appl. No.: 14/057,451

(22) Filed: Oct. 18, 2013

Related U.S. Application Data
(63) Continuation of application No. PCT/FI2011/050347, filed on Apr. 18, 2011.

(51) Int. Cl. F15B 7/00

(52) U.S. Cl. CPC F15B 7/005
USPC 417/231

(57) ABSTRACT

The invention relates to a speed regulator of a bicycle, which speed regulator is in the rear hub or the pedal centre of the bicycle, which includes one or more hydraulic pumps which is rotated by a rear pinion or by the pedals, which hydraulic pump rotates one or more hydraulic motors, which hydraulic motor/hydraulic motors rotates/rotate the rear wheel of the bicycle. According to the invention, the rotation speed of the hydraulic pump can be steplessly changed when the rear pinion or the pedals rotate at constant speed.

### CROSS REFERENCE TO RELATED APPLICATION

This application is a continuation of International Patent Application No. PCT/FI2011/050347, filed on Apr. 18, 2011.

### FIELD OF THE INVENTION

This invention relates to a speed regulator of a bicycle, which speed regulator is in the rear hub or the pedal centre of the bicycle, which includes one or more hydraulic pumps which is rotated by a rear pinion or by the pedals, which hydraulic pump rotates one or more hydraulic motors, which hydraulic motor/hydraulic motors rotates/rotate the rear wheel of the bicycle.

### BACKGROUND OF THE INVENTION

Recently, the transmission of a bicycle has been implemented either as a so-called hub gear transmission or by a front and rear derailleur combination.

In the hub gear transmission, the transmission is constructed within the rear hub by using various gear constructions. Then, the number of gears is usually 2-7.

In the front-rear derailleur combination, the bicycle includes a separate front derailleur, which is located in connection with the pedals, and a rear derailleur in the rear hub. The front then employs 1-3 gears and the number of gears at the rear is usually 6-10. At the maximum, this provides 30 speeds, the gearings of which can, and usually will, overlap. The task of the front and rear derailleur is to shift the chain from one gear to another.

The main problem of the recently known transmissions is that the number of speeds must be increased, because, when bicycling at the competing level, advantage is gained from best gearings suitable for both the terrain of the stage in question and for the cyclist's physiology. Due to this, the number of rear gears in racing bicycles is increasing all the time. In practice, this solution has been exhausted because of chain strength (the increase of rear gears requires a narrower chain). The front and rear derailleur combination necessarily creates a situation in which the front gears provide the same gearing using different rear gears. That is, different speeds partially overlap. This problem is very difficult to avoid with gear systems if not wishing to compromise the shifting speed. A particular problem of hub gear transmissions is their weight. On the other hand, the front and rear derailleur combination requires gears at the front as well as at the rear and gear levers at both gear ends, which result in weight. The recent transmission arrangements are vulnerable to malfunctions caused by dirt and wear. This is particularly true of the front and rear gear combination, as it operates in an open environment thus being extremely vulnerable to problems caused by dirt.

### SUMMARY OF THE INVENTION

The object of the invention is a speed regulator which provides a stepless speed shift from the pedals of the bicycle to the rotary motion of the rear wheel of the bicycle. A further object is that the transmission is maintenance-free.

The above disadvantages can be eliminated and the above objects achieved with a speed regulator according to the invention which is characterised by what is stated in the characterising section of claim 1. Advantageous embodiments of the invention are the subject of the dependent claims.

The most important advantages of the invention are that the speed of the rotary motion of the bicycle can be changed steplessly thus providing a gearing ratio as wide as possible even though the pedalling speed of the pedals is constant. A further advantage of the invention is that the speed regulator is located within the rear hub of the bicycle, whereby dirt cannot enter it and no other external factors can affect it, whereby the invented speed regulator is maintenance-free. An additional advantage is that the speed regulator is in the so-called oil bath, whereby its wear is minimal. The invented speed regulator also enables the limiting i.e. braking of the rotary motion of the rear wheel of the bicycle. Furthermore, an advantage is the relatively small number of moving parts and the low total weight and the possibility to novel arrangements when controlling shifting. It is evident that using the invented speed regulator provides cost savings in advanced cycling.

### BRIEF DESCRIPTION OF THE DRAWINGS

The invention will now be described in detail with reference to the accompanying figures.

FIG. 1 shows a sectional, perpendicular rear view of a speed regulator according to the invention from beyond the bicycle rear wheel, located within the rear hub of the rear wheel.

FIG. 2 shows a sectional, perpendicular side view of a body of the rear hub according to FIG. 1.

FIG. 3 shows an enlarged and sectional, perpendicular side view of a left end X of the body of the rear hub in FIG. 2.

FIG. 4 shows an enlarged and sectional, perpendicular side view of a right end Y of the body of the rear hub in FIG. 2.

FIG. 5 shows a sectional, perpendicular side view of the rear hub, which includes on the left a shaft, a transmission and on the right a drive-end shaft.

FIG. 6 shows an enlarged and sectional, perpendicular side view of a connection U of a shaft collar set at the left end of the body in FIG. 5.

FIG. 7 shows an enlarged and sectional, perpendicular side view of a connection V of a drive-end shaft collar set at the right end of the body in FIG. 5.

FIG. 8 shows a sectional, perpendicular side view of a shaft in FIG. 1, its collar, main bearing and mounting nut.

FIG. 9 shows a perpendicular rear view of the shaft in FIG. 8.

FIG. 10 shows a sectional, perpendicular side view of a drive-end shaft in FIG. 1, its collar, main bearing and mounting nut.

FIG. 11 shows a perpendicular front view of the drive-end shaft in FIG. 10.

FIG. 12 shows a perpendicular front view of a middle support in FIG. 1.

FIG. 13 shows a sectional, perpendicular side view of the middle support in FIG. 12.

FIG. 14 shows a perpendicular rear view of the middle support in FIG. 12.

FIG. 15 shows a perpendicular side view of a speed controller in FIG. 1.

FIG. 16 shows a perpendicular end view of the speed controller in FIG. 15.

FIG. 17 shows a sectional, perpendicular side view of a body of a hydraulic motor in FIG. 1.

FIG. 18 shows a sectional, perpendicular side view of a body of a hydraulic pump in FIG. 1.

FIG. 19 shows a perpendicular end view of bodies in FIGS. 17 and 18.

FIG. 20 shows a partially sectional, perpendicular side view of a motor gear train of the hydraulic motor in FIG. 1.

FIG. 21 shows a perpendicular end view of the motor gear train in FIG. 20.

FIG. 22 shows a perpendicular side view of a pump gear train of the hydraulic pump in FIG. 1.

FIG. 23 shows a perpendicular end view of the pump gear train in FIG. 22.

FIG. 24 shows a perpendicular side view of a rotating gear on the drive-end shaft in FIG. 1, its collar and slide bearing sectioned, the figure also including a pinion and its mounting nuts.

FIG. 25 shows a perpendicular end view of the rotating gear and the pinion in FIG. 24.

FIG. 26 shows a section A-A in FIG. 1 in the direction of the section.

FIG. 27 shows a section B-B in FIG. 1 in the direction of the section.

FIG. 28 shows a section C-C in FIG. 1 in the direction of the section.

FIG. 29 shows a section D-D in FIG. 1 in the direction of the section.

FIG. 30 shows a sectional, perpendicular rear view of another speed regulator according to the invention from beyond the bicycle rear wheel, located within the rear hub of the rear wheel.

FIG. 31 shows a section A-A of FIG. 30 in the direction of the section.

FIG. 32 shows a section B-B of FIG. 30 in the direction of the section.

FIG. 33 shows a section C-C of FIG. 30 in the direction of the section.

FIG. 34 shows a section D-D of FIG. 30 in the direction of the section.

FIG. 35 shows a section E-E of FIG. 30 in the direction of the section.

FIG. 36 shows a section F-F of FIG. 30 in the direction of the section.

FIG. 37 shows a section G-G of FIG. 30 in the direction of the section.

### DETAILED DESCRIPTION OF PREFERRED EMBODIMENTS

The figures show the following parts and items of a speed regulator: A body 1, in which an outer surface 1a, an inner surface 1b, a collar 1c, a shoulder 1d, an inner thread 1f, and a rotation direction arrow 1g of the body 1. The outer surface 1a includes a rotating part 1aa and the bicycle back fork includes a mounted part 1ab. A drive end 2, in which a bearing 2a. An end 3. A shaft 4, in which a support shaft 4a, a mounting nut 4b, a collar 4c, a main bearing 4d, and a hole 4e. The support shaft 4a includes a thread 4aa for the mounting nut 4b. The collar 4c includes a mounting hole 4ca, in which a seal 4caa in a groove. A drive-end shaft 5, in which a support shaft 5a, a mounting nut 5b, a collar 5c, a main bearing 5d, a hole 5e, and a rotating gear 5f. The support shaft 5a includes a thread 5aa for the mounting nut 5b. The collar 5c includes a hole 5ca and a pump-shaft bearing 5cb. The rotating gear 5f includes a sleeve 5fa and a slide bearing 5fb. A hydraulic pump 6, in which a pressure chamber 6a, a return chamber 6b, a pump gear train 6c, a gear 6d, and a body 6e of the hydraulic pump 6. The pump gear train 6c includes a rotating gear 6ca and a rotated gear 6cb. The rotating gear 6ca includes a rotation direction 6caa and a rotating shaft 6cab. The rotated gear 6cb includes a rotation direction 6cba and a shaft 6cbb. A hydraulic motor 7, in which a pressure chamber 7a, a suction chamber 7b, a motor gear train 7c, a gear 7d, a body 7e of the hydraulic motor 7, and a bearing 7f. The motor gear train 7c includes a rotating gear 7ca and a rotated gear 7cb. The rotating gear 7ca includes a rotation direction 7caa and a shaft 7cab. The rotated gear 7cb includes a rotation direction 7cba and a shaft 7cbb. A speed controller 8, in which a pressure flow element 8a and a speed control 8b, a return flow element 8c, and a motion direction shown by a motion direction arrow 8d. A middle support 9, in which a hole 9a, a main bearing 9b and an opening 9c for the speed controller. The hole 9a includes a seal 9aa. A transmission 10, in which a mounting screw 10a. A pinion 11, in which a rotation direction arrow 11a and a mounting nut 11b. A spoke 12. A bicycle back fork 13. A pressure accumulator 14. A pump lamella 15, in which an elastic element 15a and a rotating part 15b. A pressure accumulator 16, in which pressure accumulator holes 16a. A transmission 17. The pressure accumulator 14 and the pressure accumulator 16 enable the shifting of the speed controller 8.

It has now been invented that there is in the rear hub or the pedal centre of the bicycle one or more hydraulic pumps 6 rotated by the rear pinion 11 or by the pedals, which hydraulic pump 6 rotates one or more hydraulic motors 7 which hydraulic motor/hydraulic motors 7 rotates/rotate the rear wheel of the bicycle.

The figures show that the hydraulic pump 6 consists of a gear pump and the hydraulic motor 7 of a gear motor.

As invented, the rotation speed of the hydraulic pump 6 can be steplessly changed when the rear pinion 11 or the pedals rotate at constant speed. The volumes of the pressure chamber 6a and the return chamber 6b of the hydraulic pump 6 are adjustable. The pumping power of the hydraulic motor 7 can be steplessly changed when the rear pinion 11 or the pedals rotate at constant speed. The volumes of the pressure chamber 7a and the return chamber 7b of the hydraulic motor 7 are adjustable.

The volumes of the chambers 6a, 6b, 7a and 7b of the hydraulic pump 6 and the hydraulic motor 7 can be adjusted by the speed controller 8. The speed controller 8 changes the volumes of the chambers 6a, 6b, 7a and 7b by changing their size. The volumes of the chambers 6a, 6b, 7a and 7b of the hydraulic pump 6 and the hydraulic motor 7 are changed simultaneously such that the volumes of the chambers 6a, 6b of the hydraulic pump 6 and the chambers 7a, 7b of the hydraulic motor 7 change for the same amount, as one decreases the other increases for the same amount, whereby the total liquid level of the hydraulic pump 6 and the hydraulic motor 7 is constant.

Different from the figures, the hydraulic pump 6 consists of a lamella pump and the hydraulic motor 7 consists of a lamella motor.

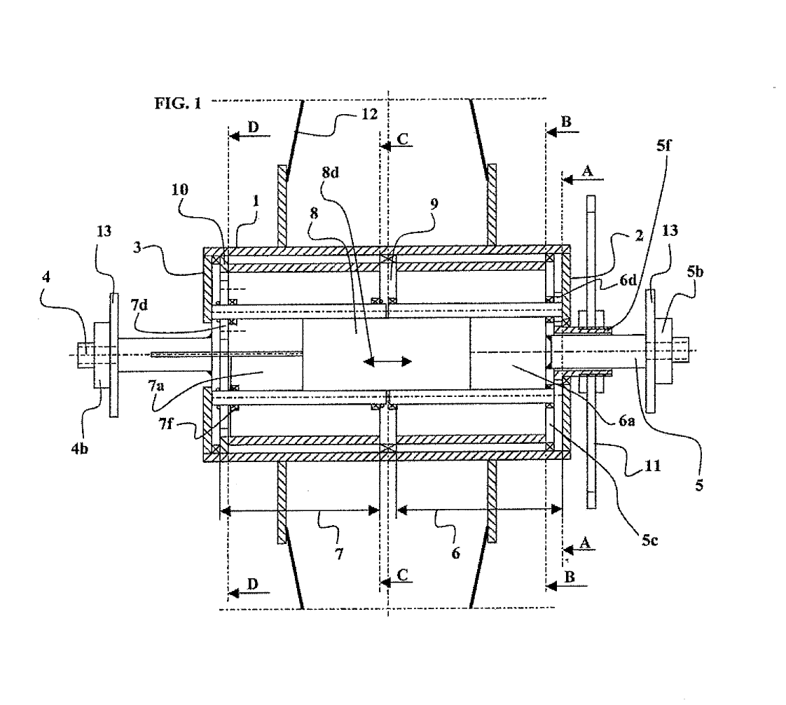

In FIG. 1, the speed regulator has been drawn perpendicularly seen from beyond the rear wheel. Within the speed regulator on the left of the figure, there is the hydraulic motor 7 and on the right the hydraulic pump 6. The hydraulic pump 6 is rotated by the pinion 11 which obtains its rotary motion by means of the chains from the pedals of the bicycle. The hydraulic pump 6 and the hydraulic motor 7 do not rotate, they are locked non-rotatable to the back fork 13 of the bicycle by the drive-end shaft 5 and the shaft 4.

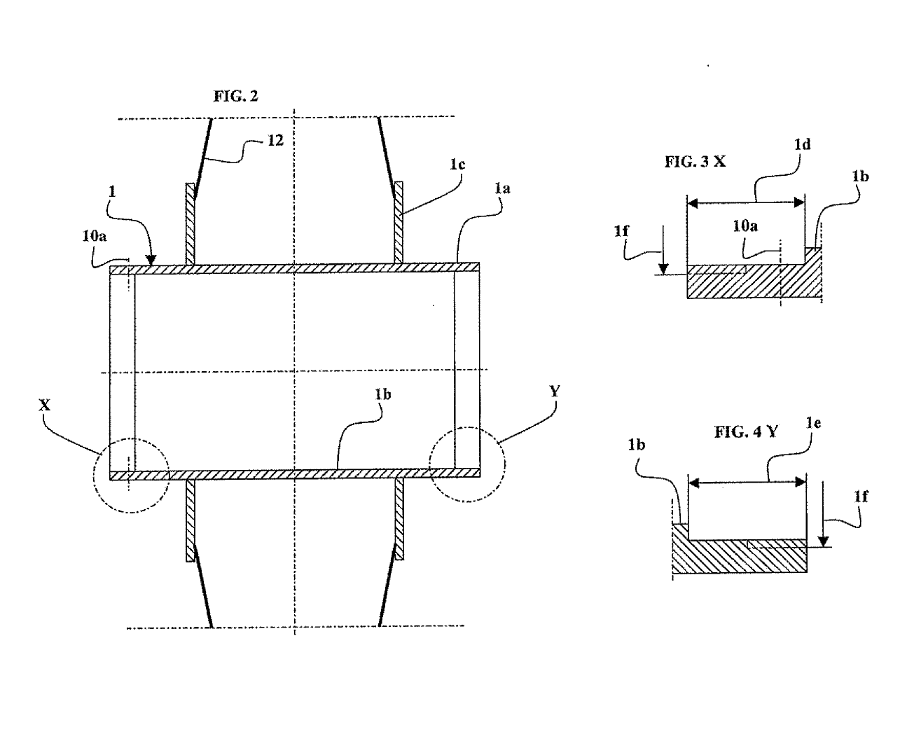

FIG. 2 shows the body 1 of the shape of a circular pipe, on the outer surface 1a of which are welded the collars 1c for the mounting points of the spokes 12. FIGS. 3 and 4 shows that both ends of the inner surface 1b of the body 1 include the shoulder 1d for mounting the transmission 10 and the drive-end shoulder 1e for mounting the collar 5c. At both ends of the inner surface 1b, there are inner threads 1f for mounting the drive end 2 and the end 3.

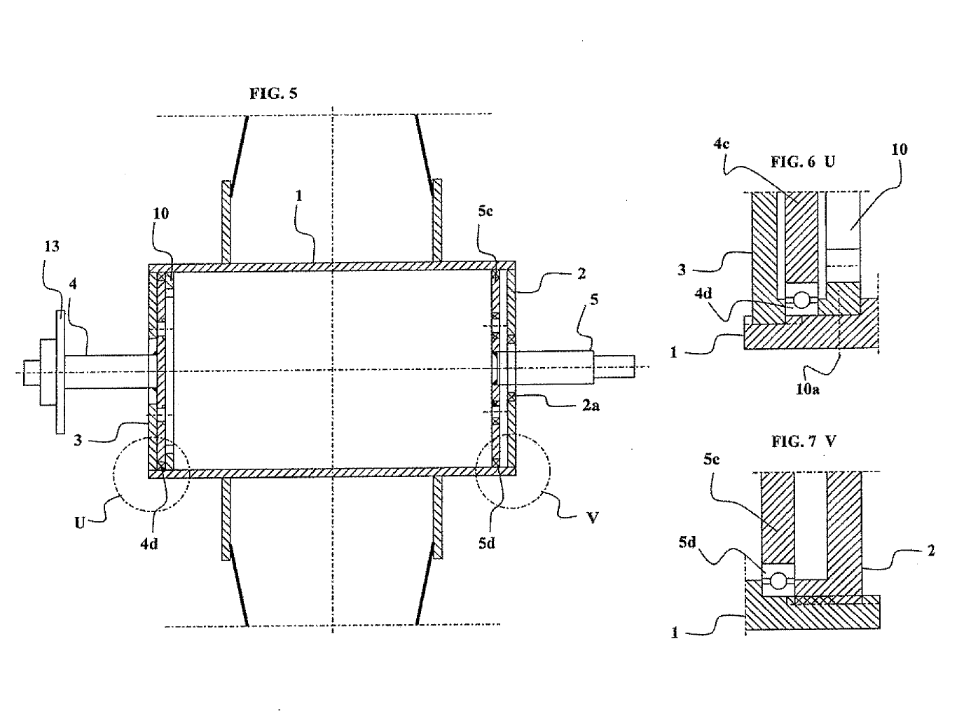

FIG. 5 shows the shaft 4 and the drive-end shaft 5 mounted on the body 1. The mounting is shown in detail in FIGS. 6 and 7. FIG. 6 shows that the end 3 presses by means of its thread the transmission 10 and the outer race of the main bearing 4d of the collar fast to the body 1. The rotation of the transmission 10 has further been prevented by the mounting screw 1g. FIG. 7 shows that the drive end 2 presses by means of its thread the outer race of the main bearing 5d of the collar 5c fast to the body 1.

FIGS. 8 and 9 show the structure of the shaft 4. To the circular collar 4c is welded fast the support shaft 4a. The outer end of the support shaft 4a includes the thread 4aa formed for mounting on the back fork 13 of the bicycle by the mounting nut 4b. On the outer race of the collar 4c, there is fast by a press fit or a suitable shoulder/locking ring structure the main bearing 4d which enables the rotation of the body 1. The collar 4c includes the mounting hole 4ca of the motor shaft, in which there is the seal 4caa in a groove. To the support shaft 4a has been bored the hole 4e for filling in liquid, the liquid can be known hydraulic oil or some other known liquid. To the thread 4aa can also be mounted the pressure accumulator, to which the liquid can flow through the hole 4e, the pressure accumulator eliminates expansion problems caused by temperature changes.

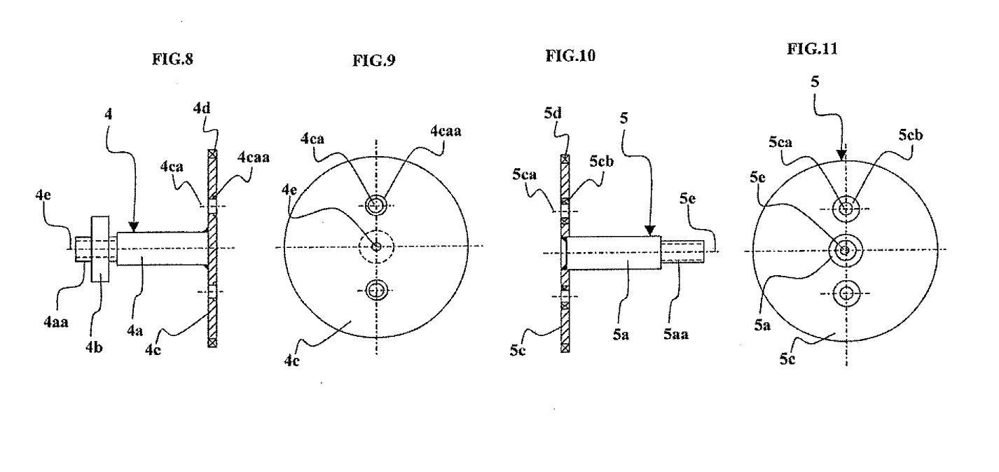

FIGS. 10 and 11 show the structure of the drive-end shaft 5. To the circular collar 5c is welded fast the support shaft 5a. The outer end of the support shaft 5a includes the thread 5aa formed for mounting on the back fork 13 of the bicycle by the mounting nut 5b. On the outer race of the collar 5c, there is fast by a press fit or a suitable shoulder/locking ring structure the main bearing 5d which enables the rotation of the body 1. The collar 5c includes the hole 5ca for the pump shaft, in which there is the pump-shaft bearing 5cb. To the thread 5aa can also be mounted the pressure accumulator, to which the liquid can flow through the hole 5e, the pressure accumulator eliminates expansion problems caused by temperature changes.

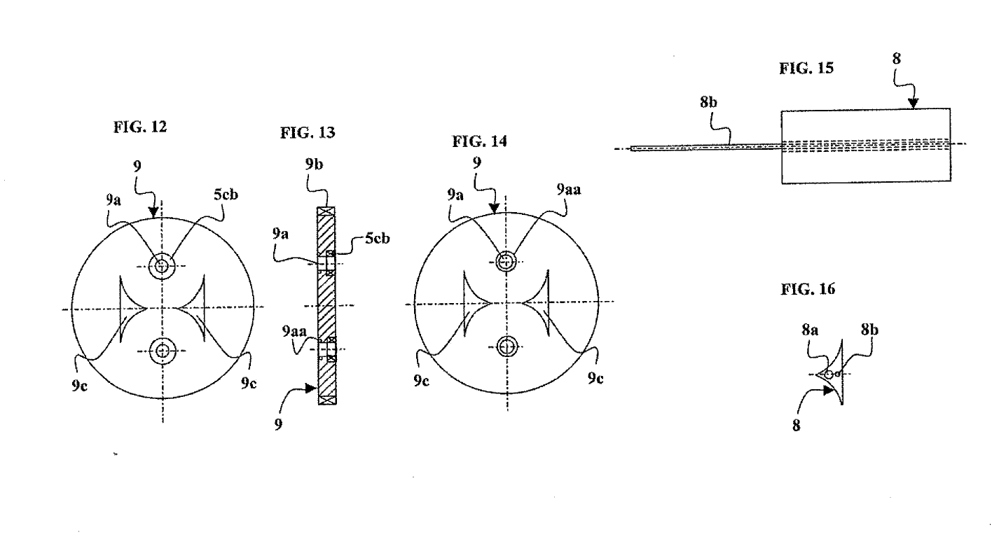

FIGS. 12, 13 and 14 show the middle support 9 between the hydraulic pump 6 and the hydraulic motor 7. The middle support 9 is a circular plate with the holes 9a for the shafts of the pump and the motor. On the outer race of the middle support 9, there is fast by a press fit or a suitable shoulder/locking ring structure the main bearing 9b which enables the rotation of the body 1.

FIGS. 15 and 16 show the speed controller 8. There are the holes 9c for the speed controller 8 in the middle support 9. The speed controller 8 moves according to the motion direction arrow 8d shown in FIG. 1 back and forth in the abutting, direction. The speed controller 8 changes the volume between the pressure chambers 6a and 7a and the volume between the return chambers 6b and 7b. The pumping volume of the hydraulic pump 6 changes when the volume of the pressure chamber 6a and the return chamber 6b is changed, i.e. the same pump provides a different liquid flow by the size change of the above chambers. The rotation speed of the hydraulic motor 7 changes when the volume of the pressure chamber 7a and the return chamber 7b is changed, i.e. the rotation speed of the motor can be changed by changing the size of the chambers. The speed controller 8 is located in a space limited by the bodies 6e and 7e of the gears 6ca, 6cb, 7ca and 7cb of the pump gear train 6c and the motor gear train 7c. The unfilled space of the speed controller 8 forms the chambers 6a, 6b, 7a and 7b.

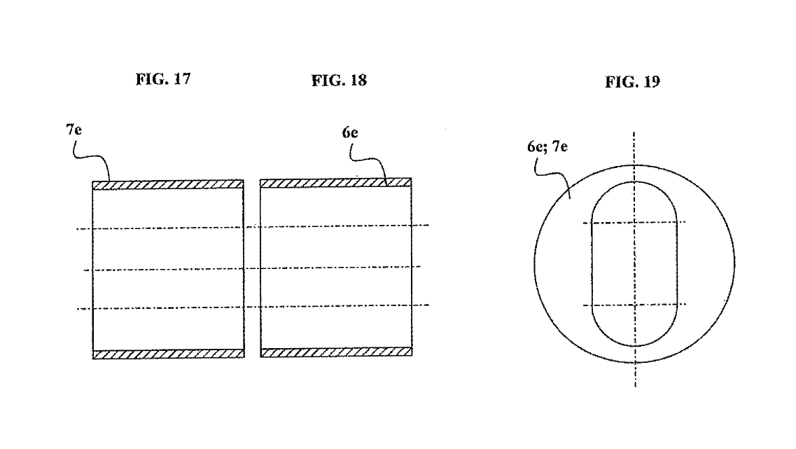

FIG. 17 shows the body 7e of the hydraulic motor 7. FIG. 18 shows the body 6e of the hydraulic pump 6. FIG. 19 shows an end view of the bodies 7e and 6e of the hydraulic motor 7 and the hydraulic pump 6. The bodies 6e and 7e consist of a circular piece in which spaces have been machined for the pump gear train 6c and the motor gear train 7c.

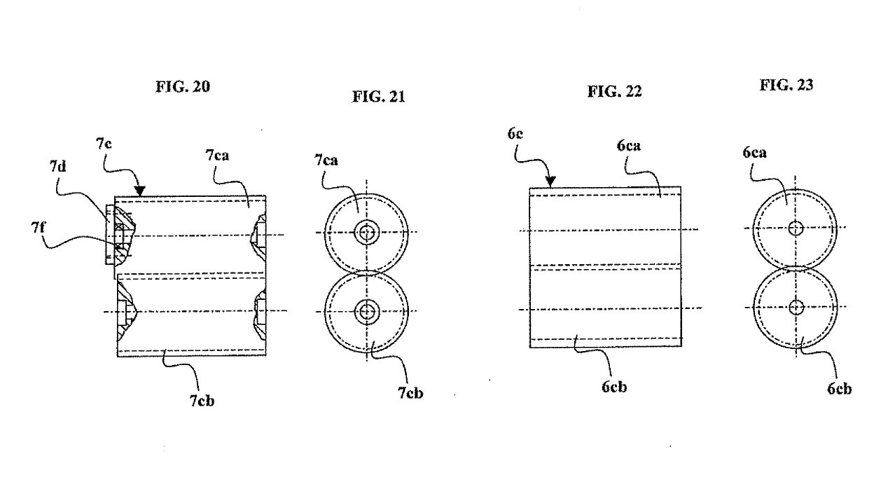

The motor gear trains 7c of FIGS. 20 and 21 include shoulders for the bearings 7f supported by which the rotating gear 7ca and the rotated gear 7cb rotate. The bearings 7f are on the non-rotatable shafts 7cab and 7cbb. The rotating gear 7ca is slightly longer than the gear 7cbb. The length difference of the gears prevents the transmission 10 from contacting the gear 7cb. In FIG. 1, to the end of the rotating gear 7ca is mounted by screws the gear 7d, which is in tooth contact with the teeth of the transmission 10. The transmission 10 consists of the gear the teeth of which are on the inner race.

FIGS. 22 and 23 show the motor gear train 6c. Upper in the figures, there is the rotating gear 6ca. The rotating gear 6ca has been mounted e.g. by a cotter bolt, a wedge or an equivalent in a known manner non-rotatably on the rotation shaft 6cab. FIG. 1 shows that to the end of the rotation shaft 6cab is mounted non-rotatably the gear 6d which is rotated by the rotating gear 5f.

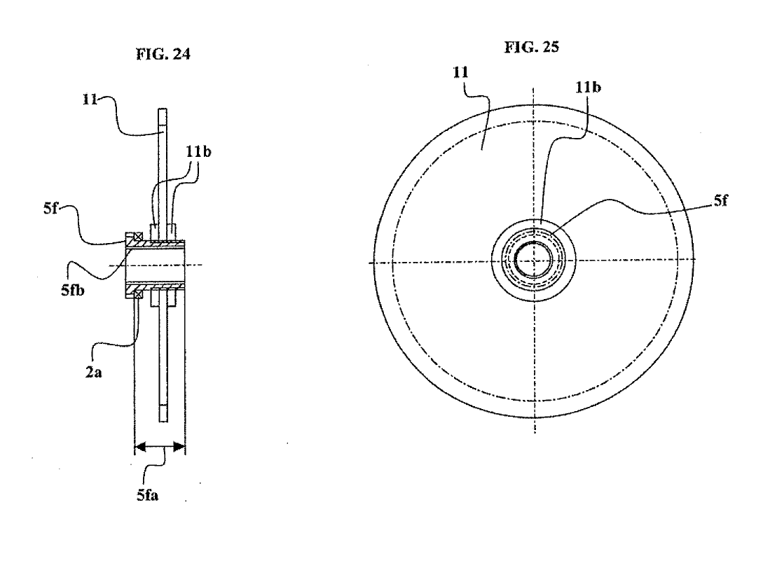

FIGS. 24 and 25 shows the sleeve 5fa of the rotating gear 5f non-rotatably mounted on the pinion 11 by the bolts 11b. The figures show the bearing 2a installed on the outer surface of the sleeve 5fa and the slide bearing 5fb installed within the sleeve 5fa. The rotating gear 5f rotates supported by the slide bearing 5fb on top of the support shaft 5a. The sleeve 5fa of the rotating gear 5f is supported on the drive end 2 by the bearing 2a.

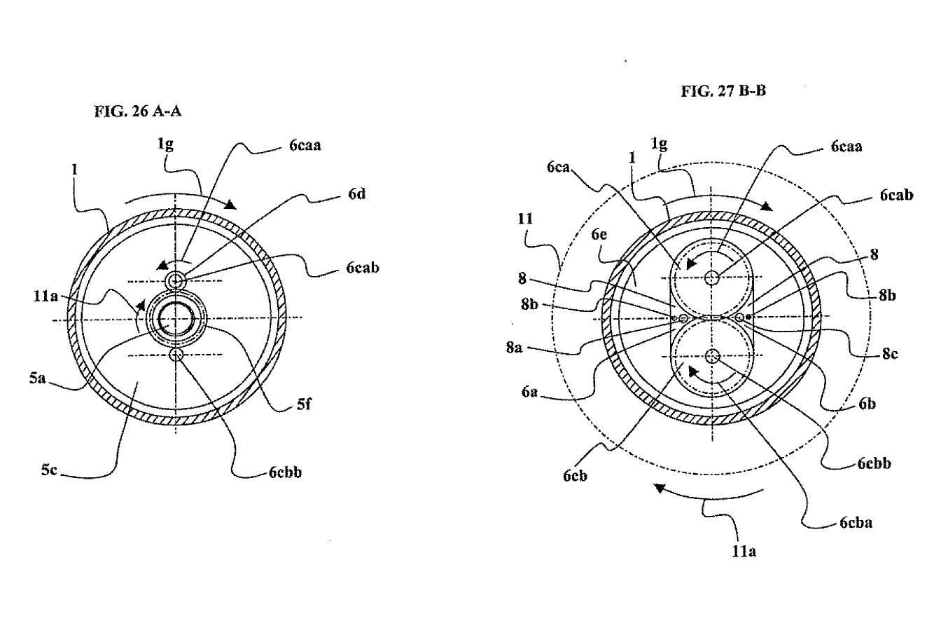

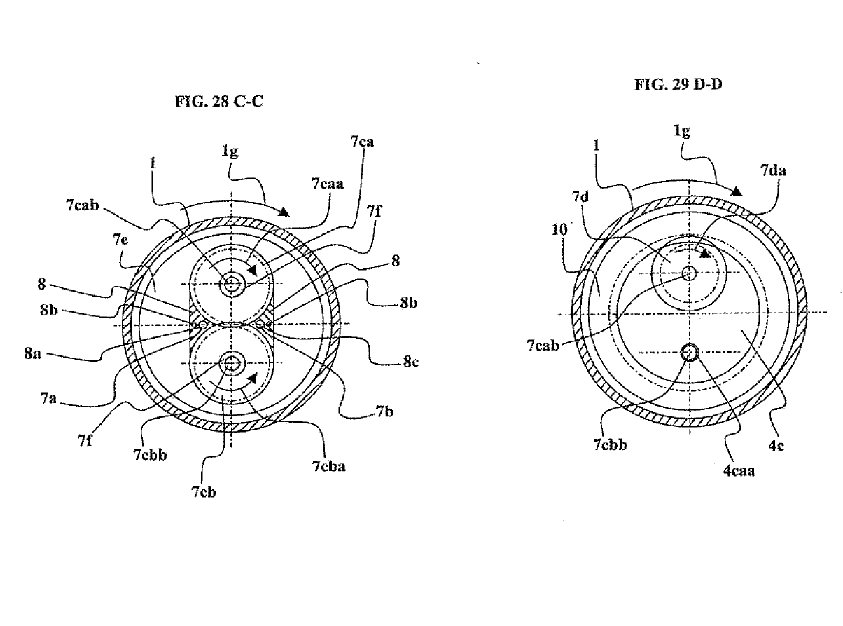

The speed regulator shown in FIGS. 1-29 operates in the following way. When pedalling the bicycle, the pedals rotate the pinion 11 via the chain in the rotation direction 11a of the pinion. The pinion 11 rotates the rotating gear 5f in the rotation direction 11a, as shown in FIG. 26. The rotating gear 5f rotates the gear 6d in the rotation direction 6caa. FIG. 27 shows the hydraulic pump 6 within the body 1. In the hydraulic pump 6 within the body 6e, there are the rotating gear 6ca and the rotated gear 6cb, the rotation directions 6caa and 6cbb are against each other, whereby on the left of FIG. 27 there is the pressure chamber 6a. From the pressure chamber 6a, liquid flows through the pressure flow element 8a of the speed controller 8 to the pressure chamber 7a of the hydraulic motor 7, whereby liquid pressure starts to rotate the motor gear train 7c of the hydraulic motor 7 in directions according to the rotation directions 7caa and 7cba shown in FIG. 28. Via the teeth of the rotating gear 7ca and the gear 7cb of the hydraulic motor 7, liquid is able to enter the return chamber 7b of the hydraulic motor 7. From the return chamber 7b, liquid flows via the return flow element 8c of the speed controller 8 to the return chamber 6b of the hydraulic pump 6. From the return chamber 6b, liquid transfers transferred by the teeth of the rotating gear 6ca and the rotated gear 6cb to the pressure chamber 6a. At the end of the rotating gear 7ca of the hydraulic motor 7 is mounted the gear 7d which rotates in the rotation direction 7da and rotates the transmission 10 and the body 1 in the rotation direction 1g in FIG. 29. The body 1 is mounted on the wheel of the bicycle, whereby as the body 1 rotates also the wheel of the bicycle rotates. When moving the speed controller 8 by the speed control 8b according to the motion direction arrow 8d, the volumes of the pressure chamber 6a and 7a and the return chamber 6b and 7b of the hydraulic pump 6 and the hydraulic motor 7 change. As the volumes of the pressure chamber 6a and 7a change in relation to each other, the operating speeds of the hydraulic pump 6 and the hydraulic motor 7 also change. As the hydraulic pump 6 rotates at constant speed, the speed controller 8 is moved such that the pressure chamber 6a and the return chamber 6b of the hydraulic pump 6 increase, the increased chambers 6a and 6b move a larger amount of liquid, whereby the pumping power of the hydraulic pump 6 increases, this larger liquid flow rotates the hydraulic motor 7 faster. When moving, the speed controller 8 decreases the pressure chamber 7a and the return chamber 7b of the hydraulic motor 7 at the same time as it increases the pressure chamber 6a and the return chamber 6b of the hydraulic pump 6, the above change in the chamber volumes causes a rapid change in rotation speeds between the hydraulic pump 6 and the hydraulic motor 7.

The pinion 11 is most advantageously provided with the so-called free-wheel mechanism which prevents the pedals from rotating when riding on the so-called neutral gear. Furthermore, it is best to insert the free mechanism between the body 1 and the bicycle wheel, if wishing to allow the bicycle wheel to rotate freely when not pedalling. Due to the free mechanism, the bicycle does not rotate the hydraulic motor 7 and the hydraulic pump 6. The free mechanism can be manufactured with technology known from free-wheel technology.

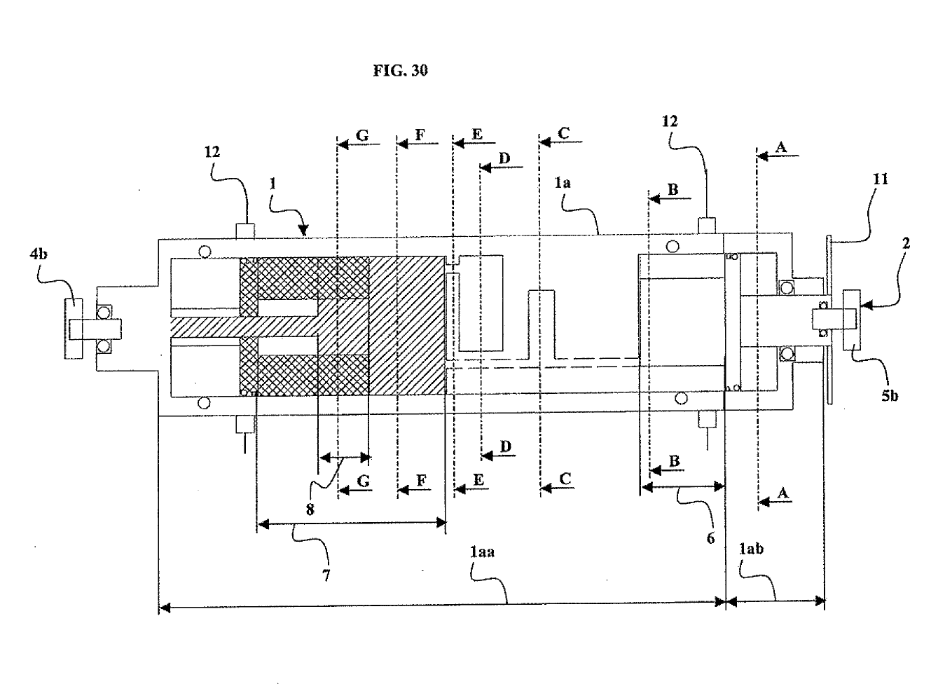

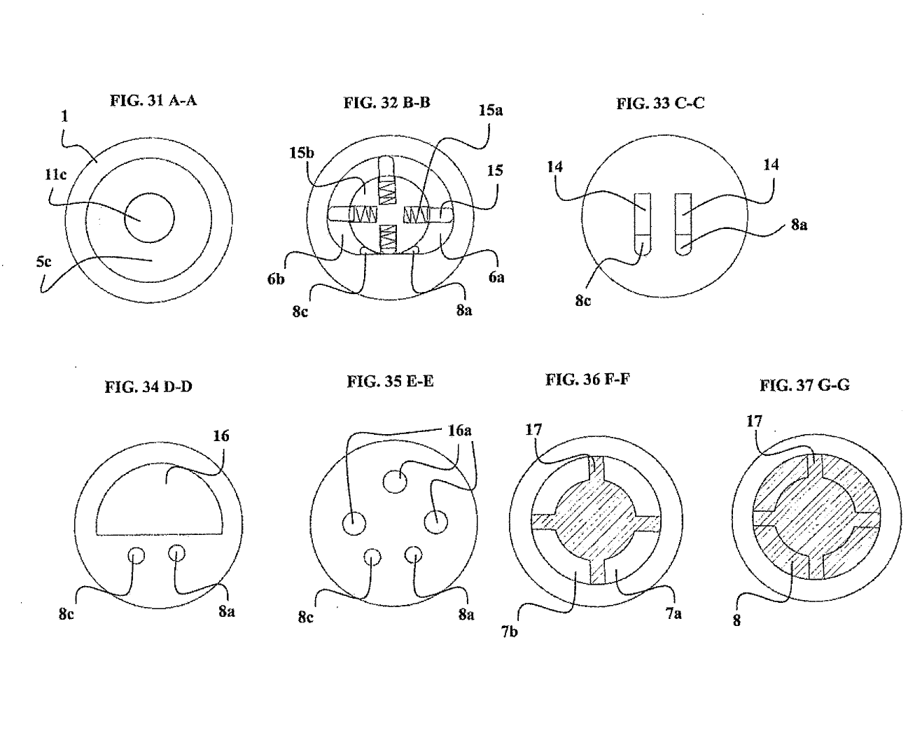

The hydraulic pump 6 of the now invented speed regulator shown in FIGS. 30-37 consists of a lamella pump and the hydraulic motor 7 consists of a lamella motor. In the speed regulator shown in FIGS. 30-37, the hydraulic pump 6 is the so-called fixed displacement pump. The speed and the pedal force of the bicycle is changed by changing the rotation speed of the hydraulic motor 7. The rotation speed is changed by moving the speed controller 8 back and forth, whereby the oil use capacity of the hydraulic motor 7 changes, with the smaller oil amount the hydraulic motor rotates quicker when the pumping flow rate of the hydraulic pump 6 is constant. Moving the speed controller 8 can be performed e.g. by an electric motor, by forcing mechanically e.g. by means of a wire or a lever. Different from the figures, the hydraulic pump 6 can be manufactured adjustable and the hydraulic motor 7 as a fixed displacement motor. Furthermore different from the figures, both the hydraulic pump 6 and the hydraulic motor 7 can be manufactured as a variable displacement hydraulic pump 6 and a variable displacement hydraulic motor 7. An advantage of the lamella pump is its more effective pumping capacity on low revolutions and, equivalently, an advantage of the lamella motor is its greater torsion on low revolutions compared with the gear pump and the gear motor.

All parts of the invented speed regulator of a bicycle can be manufactured of known materials by known machines.

It is evident to those skilled in the art that the invention is not limited solely to the alternatives described above, but many modifications are possible within the scope of the inventive idea defined by the enclosed claims.

1. A speed regulator of a bicycle, in which
speed regulator is in the rear hub or the pedal centre of the bicycle, which includes one or more hydraulic pumps, which is (are) rotated by a rear pinion or by the pedals,
the hydraulic pump rotates one or more hydraulic motors,
hydraulic motor/hydraulic motors rotates/rotate the rear wheel of the bicycle, and
there are means for changing the rotation speed of the hydraulic motor steplessly when the rear pinion or the pedals rotate at constant speed.

2. A speed regulator of a bicycle according to claim 1, in which
there are means for adjusting volumes of a pressure chamber and a return chamber of the hydraulic pump.

3. A speed regulator of a bicycle according to claim 1, in which
there are means for changing a pumping power of the hydraulic motor steplessly when the rear pinion or the pedals rotate at constant speed.

4. A speed regulator of a bicycle according to claim 3, in which
there are means for adjusting volumes of a pressure chamber and a return chamber of the hydraulic motor.

5. A speed regulator of a bicycle according to claim 2, in which
there are means for changing a pumping power of the hydraulic motor steplessly when the rear pinion or the pedals rotate at constant speed;
there are means for adjusting volumes of a pressure chamber and a return chamber of the hydraulic motor; and
the volumes of the chambers of the hydraulic pump and the hydraulic motor are adjustable by a speed controller.

6. A speed regulator of a bicycle according to claim 5, in which
the speed controller changes the volumes of the chambers, changing the volume referring to a change in the sizes of the chambers.

7. A speed regulator of a bicycle according to claim 6, in which
the volumes of the chambers of the hydraulic pump and the hydraulic motor are changeable at the same time such that the volumes of the chambers of the hydraulic pump and the chambers of the hydraulic motor change for the same amount, as one decreases the other increases for the same amount, whereby the total liquid level of the hydraulic pump and the hydraulic motor is constant.
